(19) United States
(12) Patent Application Publication
(10) Pub. No.: US 2010/0082313 A1
(43) Pub. Date: Apr. 1, 2010

(54) Optical Lithographic Process Model Calibration

(76) Inventor: Edita Tejnil, Cupertino, CA (US)

Correspondence Address: MENTOR GRAPHICS CORP.;PATENT GROUP, 8005 SW BOECKMAN ROAD, WILSONVILLE, OR, 97070-7777, US

(21) Appl. No.: 12/416,044

(22) Filed: Mar. 31, 2009

Related U.S. Application Data
(60) Provisional application No. 61/041,155, filed on Mar. 31, 2008.

(51) Int. Cl. G06G 7/58

(52) U.S. Cl. 703/12

(57) ABSTRACT

Various implementations of the invention provide methods and apparatus for calibrating models of an optical lithographic process. In various implementations, a complete model of an optical lithographic process may be formed by combining different physical ranges and components describing the optical lithographic process. With various implementations of the invention, an optical lithographic process model may be calibrated by generating and applying a set of test patterns to the optical lithographic process, identifying test patterns and associated measured results that correspond to the discrete components of the optical lithographic model, calibrating the discrete components of the optical lithographic model based on the identified test patterns and measured results, and combining the calibrated components into a complete model. In some implementations of the invention, the discrete components of the optical lithographic model represent different physical effects of the optical lithographic process. Alternately or additionally, with various implementations of the invention the generated test patterns may include test structures sensitive to proximity effects, long-range pattern density, and long-range process non-uniformity.

### RELATED APPLICATIONS

This application claims priority under 35 U.S.C. §119 to U.S. Provisional Patent Application No. 61/041,155, entitled “Mask Process Correction,” filed on Mar. 31, 2008, and naming Edita Tenjil et al. as inventors, which application is incorporated entirely herein by reference.

### FIELD OF THE INVENTION

The invention relates to the field of integrated circuit design and manufacturing. More particularly, various implementations of the invention are applicable to methods and apparatuses for calibrating models that describe an optical lithographic process.

### BACKGROUND OF THE INVENTION

Electronic circuits, such as integrated microcircuits, are used in a variety of products, from automobiles to microwaves to personal computers. Designing and fabricating microcircuit devices (often referred to as integrated circuits (ICs)) typically involves many steps, sometimes referred to as the “design flow.” The particular steps of a design flow often are dependent upon the type of microcircuit, its complexity, the design team, and the microcircuit fabricator or foundry that will manufacture the microcircuit. Typically, software and hardware “tools” verify the design at various stages of the design flow by running software simulators and/or hardware emulators. These steps aid in the discovery of errors in the design, and allow the designers and engineers to correct or otherwise improve the design.

Several steps are common to most design flows. Initially, the specification for a new circuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logic of the circuit is then analyzed, to confirm that it will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This device design generally corresponds to the level of representation displayed in conventional circuit diagrams. The relationships between the electronic devices are then analyzed, to confirm that the circuit described by the device design will correctly perform the desired functions. This analysis is sometimes referred to as “formal verification.” Additionally, preliminary timing estimates for portions of the circuit are often made at this stage, using an assumed characteristic speed for each device, and incorporated into the verification process.

Once the components and their interconnections are established, the design is again transformed, this time into a physical design that describes specific geometric elements. This type of design often is referred to as a “layout” design. The geometric elements, which typically are polygons, define the shapes that will be created in various layers of material to manufacture the circuit. Typically, a designer will select groups of geometric elements representing circuit device components (e.g., contacts, channels, gates, etc.) and place them in a design area. These groups of geometric elements may be custom designed, selected from a library of previously-created designs, or some combination of both. Lines are then routed between the geometric elements, which will form the wiring used to interconnect the electronic devices. Layout tools (often referred to as “place and route” tools), such as Mentor Graphics' IC Station or Cadence's Virtuoso, are commonly used for both of these tasks.

IC layout descriptions can be provided in many different formats. The Graphic Data System II (GDSII) format is a popular format for transferring and archiving two-dimensional graphical IC layout data. Among other features, it contains a hierarchy of structures, each structure containing layout elements (e.g., polygons, paths or polylines, circles and textboxes). Other formats include an open source format named Open Access, Milkyway by Synopsys, Inc., EDDM by Mentor Graphics, Inc., and the more recent Open Artwork System Interchange Standard (OASIS) proposed by Semiconductor Equipment and Materials International (SEMI). These various industry formats are used to define the geometrical information in IC layout designs that are employed to manufacture integrated circuits. Once the microcircuit device design is finalized, the layout portion of the design can be used by fabrication tools to manufacturer the device using a photolithographic process.

There are many different fabrication processes for manufacturing a circuit, but most processes include a series of steps that deposit layers of different materials on a substrate, expose specific portions of each layer to radiation, and then etch the exposed (or non-exposed) portions of the layer away. For example, a simple semiconductor device component could be manufactured by the following steps. First, a positive type epitaxial layer is grown on a silicon substrate through chemical vapor deposition. Next, a nitride layer is deposited over the epitaxial layer. Then specific areas of the nitride layer are exposed to radiation, and the exposed areas are etched away, leaving behind exposed areas on the epitaxial layer, (i.e., areas no longer covered by the nitride layer). The exposed areas then are subjected to a diffusion or ion implantation process, causing dopants, for example phosphorus, to enter the exposed epitaxial layer and form charged wells. This process of depositing layers of material on the substrate or subsequent material layers, and then exposing specific patterns to radiation, etching, and dopants or other diffusion materials, is repeated a number of times, allowing the different physical layers of the circuit to be manufactured.

Each time that a layer of material is exposed to radiation, a mask must be created to expose only the desired areas to the radiation, and to protect the other areas from exposure. The mask is created from circuit layout data. That is, the geometric elements described in layout design data define the relative locations or areas of the circuit device that will be exposed to radiation through the mask. A mask or reticle writing tool is used to create the mask based upon the layout design data, after which the mask can be used in a photolithographic process. The ideal geometric shape that a designer would like to create using the mask is often referred to as the intended or target image, while the image that is actually created on the substrate by employing the mask is referred to as the printed image.

As designers and manufacturers continue to increase the number of circuit components in a given area and/or shrink the size of circuit components, the shapes reproduced on the substrate become smaller and are placed closer together. This reduction in feature size increases the difficulty of faithfully reproducing the image intended by the layout design onto the substrate. Various techniques exist for mitigating these effects, such as optical process (or proximity) correction (OPC) and mask process correction (MPC). Conventional mask process correction has included pattern and dose-based correction techniques. These techniques are discussed in “Dose-Modulation-Induced Mask CD Error On Simulation Correction Of Fogging And Loading Effect,” by H. Lee et al., Proceedings Of SPIE, Vol 4754, pp. 205-216, 2002, which article is incorporated entirely herein by reference. Additionally, mask process correction has been applied to correct the etch loading through dose adjustments. This is discussed in “Mask CD Uniformity Improvement By Dry Etching Loading Effect Correction,” by J. Kotani et al., Proceedings of SPIE, vol. 5256, pp. 758-765, 2003, which article is incorporated entirely herein by reference.

### SUMMARY OF THE INVENTION

Various implementations of the invention provide methods and apparatus for calibrating models of an optical lithographic process. In various implementations, a complete model of an optical lithographic process may be formed by combining different physical ranges and components describing the optical lithographic process. With various implementations of the invention, an optical lithographic process model may be calibrated by generating and applying a set of test patterns to the optical lithographic process, identifying test patterns and associated measured results that correspond to the discrete components of the optical lithographic model, calibrating the discrete components of the optical lithographic model based on the identified test patterns and measured results, and combining the calibrated components into a complete model. In some implementations of the invention, the discrete components of the optical lithographic model represent different physical effects of the optical lithographic process. Alternately or additionally, with various implementations of the invention the generated test patterns may include test structures sensitive to proximity effects, long-range pattern density, and long-range process non-uniformity.

In various implementations of the invention, separate components are calibrated to accurately describe both the proximity effects and the long range effects of the modeled optical lithographic process. With various implementations of the invention, the long range components may be calibrated by first removing any proximity effects from the measured results. The form of the long range component models may be determined, for example, based upon the process uniformity of the measured results. With various implementations of the invention, the density loading ranges of the long range components may be determined based upon the density loading of the measured results. Subsequently, the calibrated long range model may be used to remove any long range effects from the measured results. In various implementations of the invention, the proximity components of the measured results may be utilized to calibrate the proximity components, such as patterning and etch, of the optical lithographic model.

With various implementations of the invention, the proximity measurements at different mask field locations may be used to remove any long range bias, such as position bias, from the measured results. Subsequently, the proximity component models may be calibrated based upon the measured results. With further implementations of the invention, the calibrated proximity component models may be used to remove any proximity effects from the measured results, enabling any long range component models to be calibrated. Further still, with various implementations of the invention, the proximity component models and the long range component models are checked for consistency and combined during a layout design adjustment step, such as optical proximity correction.

These and additional aspects of the invention will be further understood from the following detailed disclosure of illustrative embodiments.

### BRIEF DESCRIPTION OF THE DRAWINGS

The present invention will be described by way of illustrative embodiments shown in the accompanying drawings in which like references denote similar elements, and in which:

FIG. 1 illustrates an illustrative computing environment;

FIG. 2 illustrates a portion of the illustrative computing environment of FIG. 1, shown in further detail;

FIG. 3 illustrates a layout design feature;

FIG. 4 illustrates the layout design feature of FIG. 3, shown in Further detail;

FIG. 5A illustrates a portion of a target layout design feature and an associated simulated printed image;

FIG. 5B illustrates the target layout design feature portion and the associated simulated printed image of FIG. 3, shown in further detail;

FIG. 5C illustrates the layout design feature of FIG. 3, modified by an optical proximity correction process;

FIG. 5D illustrates the layout design feature of FIG. 5C, shown in further detail;

FIG. 6 illustrates a lithographic model calibration flow 601;

FIG. 7 illustrates a mask test pattern;

FIG. 8 illustrates a component lithographic model calibration flow 801;

FIG. 9 illustrates a component lithographic model calibration flow 901;

FIG. 10 illustrates a mask feature; and

FIG. 11 illustrates a shape based layout design correction process.

### DETAILED DESCRIPTION OF ILLUSTRATIVE IMPLEMENTATIONS

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods. Additionally, the detailed description sometimes uses terms like “determine” to describe the disclosed methods. Such terms are high-level abstractions of the actual operations that are performed. The actual operations that correspond to these terms will vary depending on the particular implementation and are readily discernible by one of ordinary skill in the art.

Some of the methods described herein can be implemented by software stored on a computer readable storage medium, or executed on a computer. Additionally, some of the disclosed methods may be implemented as part of a computer implemented electronic design automation (EDA) tool. The selected methods could be executed on a single computer or a computer networked with another computer or computers. For clarity, only those aspects of the software germane to these disclosed methods are described; product details well known in the art are omitted.

### Illustrative Computing Environment

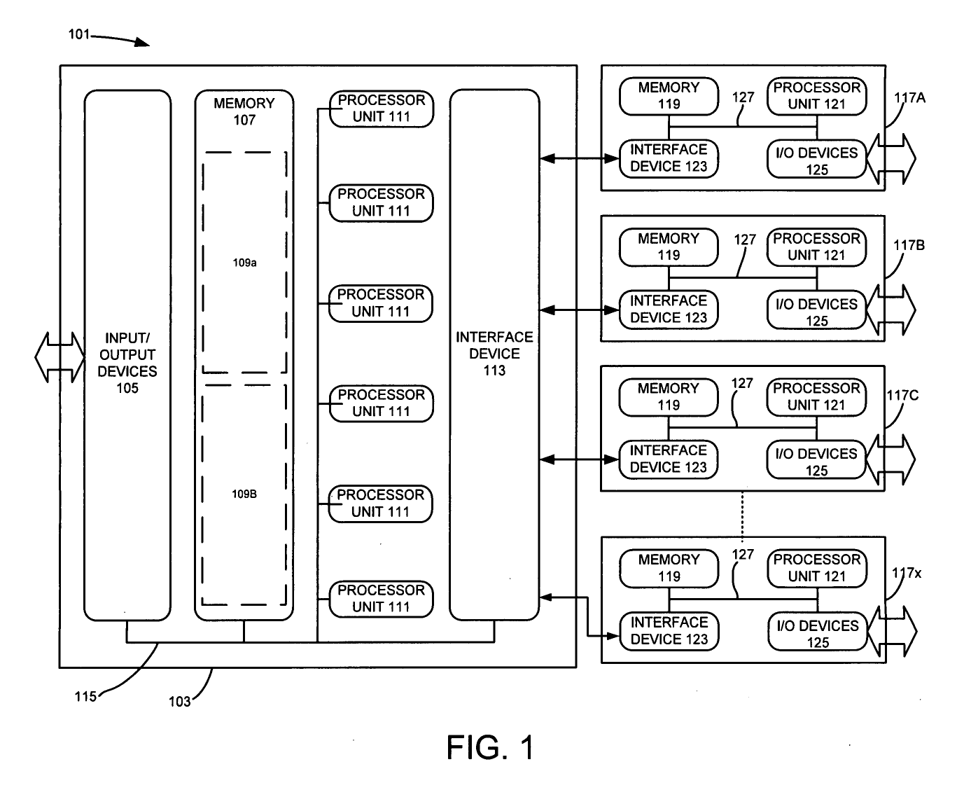

Various embodiments of the invention are implemented using computer executable software instructions executed by one or more programmable computing devices. Because these examples of the invention may be implemented using software instructions, the components and operation of a generic programmable computer system on which various embodiments of the invention may be employed is described. Further, because of the complexity of some electronic design automation processes and the large size of many circuit designs, various electronic design automation tools are configured to operate on a computing system capable of simultaneously running multiple processing threads. The components and operation of a computer network 101 having a host or master computer and one or more remote or slave computers therefore will be described with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as random access memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom manufactured processor, such as a microprocessor designed to optimally perform specific types of mathematical operations. The interface device 113, the processor units 111, the memory 107 and the input/output devices 105 are connected together by a bus 115.

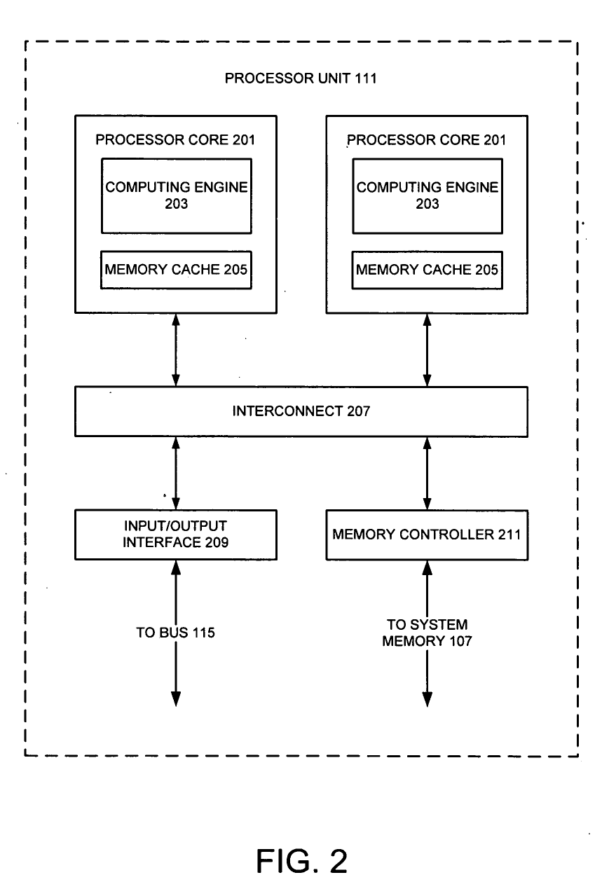

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell Broadband Engine™ (Cell) microprocessor created by Sony Corporation, Toshiba Corporation and IBM Corporation, the interconnect 207 may be implemented as an interconnect bus. With other processor cores 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interfaces 209 and a memory controller 211. The input/output interface 209 provides a communication interface between the processor unit 111 and the bus 115. Similarly, the memory controller 211 controls the exchange of information between the processor unit 111 and the system memory 107. With some implementations of the invention, the processor units 111 may include additional components, such as a high-level cache memory accessible shared by the processor cores 201.

While FIG. 2 shows one illustration of a processor unit 111 that may be employed by some embodiments of the invention, it should be appreciated that this illustration is representative only, and is not intended to be limiting. For example, some embodiments of the invention may employ a master computer 103 with one or more Cell processors. The Cell processor employs multiple input/output interfaces 209 and multiple memory controllers 211. Also, the Cell processor has nine different processor cores 201 of different types. More particularly, it has six or more synergistic processor elements (SPEs) and a power processor element (PPE). Each synergistic processor element has a vector-type computing engine 103 with 128×128 bit registers, four single-precision floating point computational units, four integer computational units, and a 256 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units 111 each having three cores, a multi-core processor unit 111 with four cores together with two separate single-core processor units 111, or other desired configuration.

Returning now to FIG. 1, the interface device 113 allows the master computer 103 to communicate with the slave computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the slave computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each slave computer 117 may include a memory 119, a processor unit 121, an interface device 123, and, optionally, one more input/output devices 125 connected together by a system bus 127. As with the master computer 103, the optional input/output devices 125 for the slave computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the slave computers 117 to communicate with the master computer 103 over the communication interface.

In the illustrated example, the master computer 103 is a multi-processor unit computer with multiple processor units 111, while each slave computer 117 has a single processor unit 121. It should be noted, however, that alternate implementations of the invention may employ a master computer having single processor unit 111. Further, one or more of the slave computers 117 may have multiple processor units 121, depending upon their intended use, as previously discussed. Also, while only a single interface device 113 or 123 is illustrated for both the master computer 103 and the slave computers 117, it should be noted that, with alternate embodiments of the invention, either the master computer 103, one or more of the slave computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as random access memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the slave computers 117 may alternately or additions be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only and is not intended to suggest any limitation as to the scope of use or functionality of alternate embodiments of the invention.

### Shape Based Process Correction

In a photolithographic process, as explained above, electromagnetic radiation is transmitted through selectively radiation-transmissive areas of a mask. The radiation passing through these transmissive areas then irradiates desired portions of a photoresistive material on a layer of semiconductor substrate. The mask in turn is created from layout design data describing the geometric features that should be manufactured on the semiconductor substrate, by way of the photolithographic process, in order to create the desired circuit. For example, if a transistor should have a rectangular gate region, then the layout design data will include a rectangle defining that gate region. This rectangle in the layout design data is then implemented in a mask for “printing” a rectangular image corresponding to the gate region onto the substrate.

Additionally, as discussed modern integrated circuit design and manufacturing flows typically include various layout design adjustment steps, occasionally referred to as pattern correction steps, such as for example mask process correction. Additionally, as further stated, conventional mask process correction has been applied to dose correction techniques. More particularly, conventional mask process correction improved the critical dimension uniformity by controlling the exposure dose of the lithographic process. The critical dimension uniformity may be further improved by including shape based correction into the mask process correction flow.

Shape based mask process correction is similar to optical process correction in that both processes adjust the shapes within a layout design for a mask. However, shape based mask process correction seeks to account for the difference between the ideal target mask shapes and the actual mask shapes. Whereas optical proximity correction adjusts the mask shapes in order to improve the fidelity of the optical lithographic process. Those of skill in the art will appreciate that when discussing optical proximity correction and shape based mask process correction, data representing shapes to be created in a physical photomask is modified. Various tools exists for modifying mask layout data, such as the Calibre family of software design tools available from Mentor Graphics Corporation of Wilsonville, Oreg.

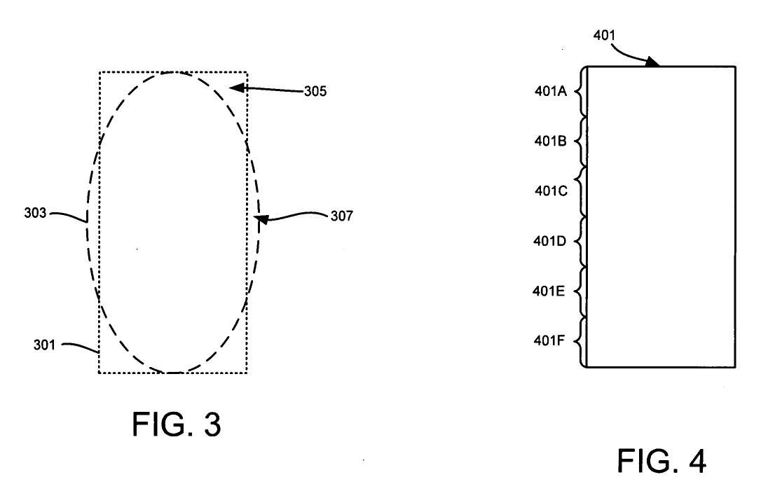

In order to more fully understand the modeling techniques discussed herein, an illustrative shape-based correction process is discussed. As discussed above, a designer may intend for an optical lithographic process to reproduce the rectangular shape or “target” image 301 illustrated in FIG. 3. Because of various optical effects, such as, for example, diffraction the optical lithographic process may only produce the actual or “printed” image 303. As seen in this figure, the printed image 303 is substantially narrower in the corners (e.g., corner 305) than the ideal rectangular shape intended for the target image 301. Likewise, the printed image 303 may have areas (e.g., 307) that extend beyond the ideal rectangular shape intended for the target image 301.

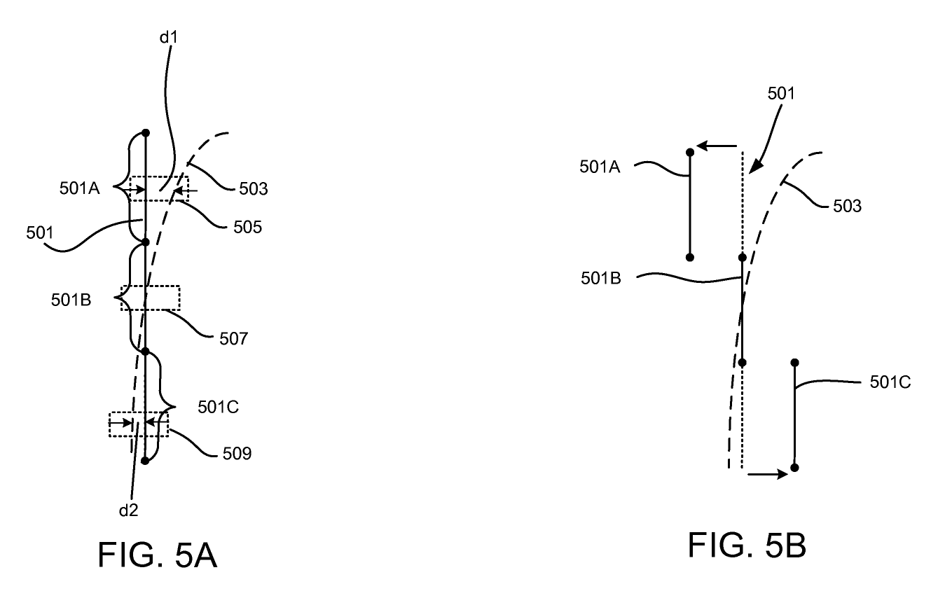

To correct for these optical distortions, many circuit designers will attempt to modify the layout design data to enhance the resolution of the images that will be produced during the photolithographic process. A resolution enhancement technique often employed by designers is referred to as optical proximity (or process) correction (OPC). Optical proximity correction is often applied to a layout design, in an effort to better control the amplitude and/or phase of the radiation that will be transmitted by the resulting mask at specific locations. In a typical optical proximity correction process, the edges of the geometric elements in the design are fragmented. For example, as shown in FIG. 4, an edge of the geometric element 401, (i.e., the geometric element in the layout data used to create the mask feature that will produce the printed image 303), is fragmented into edge segments 401A-401F. The partitioning of edge segments within a given layout design depends upon the specific optical proximity correction process parameters, often referred to as the optical proximity correction “recipe.” The recipe specifies, among other factors, the size of the edge segments. Accordingly, not all edges within a layout design will be fragmented in every optical proximity correction process. It also should be noted, the size of the edge segments, such as the edge segments 401A-401F, resulting from fragmenting an edge of a geometric element within a layout design can vary depending upon the layout design, the optical proximity correction process, or the optical proximity correction process recipe.

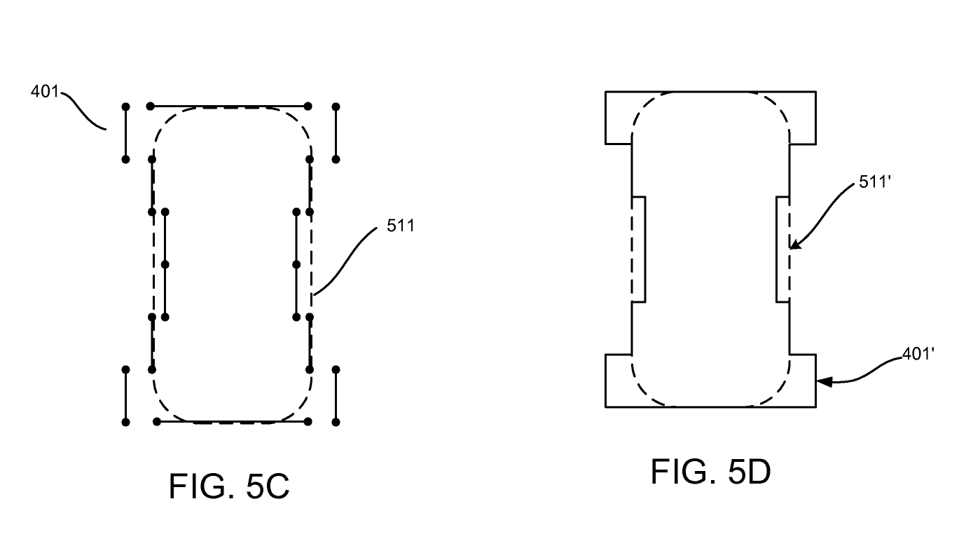

In attempting to correct for optical distortions within the photolithographic process, the optical proximity correction process simulates the printed image 303. That is, the photolithographic process is simulated in order to produce a simulated printed image. FIG. 5A illustrates a simulated printed image 503 (corresponding to the printed image 303) based upon a target image 501. The edge of the geometric element 501 has been fragmented into edge segments 501A, 501B, and 501C, also shown in this figure. Subsequently, the simulated image 503 is compared to the target image 501. Typically, this comparison is done at each edge segment. For example, as shown in FIG. 5, the target image 501 is a distance d1 away from the simulated printed image 503 at the edge segment 501A, the target image 501 is a distance d2 away from the simulated printed image 503 at the edge segment 501C, while the target image 501 intersects the simulated printed image 503 at the edge segment 501B. The distances between the target image 501 and the simulated printed image 503 are often referred to as the edge placement error (EPE). Accordingly, in a typical optical proximity correction processes, each edge segment, as well as each unfragmented edge, will have an associated edge placement error. The location where the edge placement error is computed is often referred to as a simulation site. For example, FIG. 5A illustrates the simulation sites 505-509. In conventional optical proximity correction processes, the location of simulation sites does not change during the optical proximity correction process.

Following simulation and calculation of the edge placement error, the edge segments are individually moved in order to improve the resolution of the simulated printed image for the resulting mask. For example, as shown in FIG. 5B, the edge segment 501A is displaced in a direction away from the target image 501, in an effort to widen the corresponding portion of the image that would be produced by the resulting mask at the location of the edge segment 501A. Similarly, the edge segment 501C is displaced in a direction away from the target image 501, in an effort to narrow the corresponding portion of the image that would produced by the resulting mask at the location of the edge segment 501C. With various implementations of the invention, the displacement value will be a vector. More particularly, a displacement value will often contain a distance component and a direction component.

This process of simulating the image that would be produced using a mask feature, comparing the simulated image to the target image, and moving edge segments accordingly may be repeated a number of times. Each cycle of simulation, compare, and move is referred to as an iteration of the optical proximity correction process. With various implementations of the invention, a final simulation process is performed after the last iteration for purposes of reporting results to the user. For example, the final simulated printed image may be displayed to the user via a computer monitor. Alternatively or additionally, the value of the edge placement error at selected edge fragments may be provided to the user. In still other implementations, those edge fragments having an edge placement error greater than a threshold value may alternately or additionally be provided to the user.

Typically, selecting edge segments to be moved during a given iteration, and the distance the edge segments are displaced, is determined based upon the edge placement errors for the edge fragment and the optical proximity correction process recipe. For example, an optical proximity correction process may move an edge segment some factor of the edge placement error for that edge fragment away from the simulated printed image or the target image. Additionally, each edge segment may be displaced the same distance during a given iteration. The specific parameters that control edge movement are dependent upon the tool used to implement the optical proximity correction process and the optical proximity correction process recipe.

Typically, the optical proximity correction process is allowed to iterate until the simulated image is sufficiently similar to the target image (e.g., both d1 and d2 are smaller than a threshold value), or until it is determined that the edge segments have converged on locations where no further movement of the edge segments will improve the simulated image. FIG. 5C shows the geometric element 401 of FIG. 4, with the edges fragmented and displaced, along with a simulated printed image 511 that has been simulated based upon the location of the displaced edge segments. Once the final positions of the edge segments are determined in the layout design data, as shown in FIG. 5C, a modified mask feature can be created from the corrected layout design data. FIG. 5D shows a modified mask feature 401′, produced from the displaced edge segments of the geometric element 401 as shown in FIG. 5C. Additionally, the image 511′ produced by the modified mask feature 401′ is shown. FIG. 5D illustrates that the modified mask feature 401′ produces a printed image 511′ that more closely corresponds to the target image 301. The mask feature 401′ is often referred to as the optical proximity correction contour.

As optical proximity correction has been explained in detail above, the specifics of the various individual optical proximity correction processes disclosed herein are omitted from the balance of this disclosure. Instead general operations germane to an optical proximity correction process, for example, edge segment, displacement, iteration, convergence, or verification are used to describe the optical proximity correction operations implemented with various embodiments of the present invention. The abstract terms used to describe the optical proximity correction process are to be interpreted in light of the above description of optical proximity correction, the accompanying figures, and the knowledge possessed by those of ordinary skill in the art.

To implement a shape based mask process correction flow, models of the optical lithographic process are needed to simulate printed images. As summarized above, various implementations of the invention provide methods and apparatuses for calibrating optical lithographic models suitable for utilization in a pattern correction process, such as a mask process correction flow.

### Mask Process Correction Modeling

As stated above, mask process correction seeks to account for the difference between the ideal mask shapes, such as for example mask feature 511′ of FIG. 5D and the shapes that will be actually realized in a manufactured mask. This is discussed in “Advanced Mask Process Modeling For 45-nm And 32-nm Nodes,” by Edita Tejnil et al., Proceedings Of SPIE, vol. 6924, 2008, which article is incorporated entirely herein by reference. Often imperfections in the mask are the result of finite patterning resolution, resist development, etch loading, process non-uniformity and pattern density loading effects. The cause of mask errors is discussed further in “Methods For Analyzing And Compensating For Systematic Mask CD Errors,” by P. Buck et al., Solid State Technology, December 2006, which article is incorporated entirely herein by reference. Imperfections in manufactured masks, often referred to as critical dimension errors or edge placement errors in the mask, may be classified by their range. More particularly, the mask imperfections may be categorized based upon the distance, or range, with which the imperfection affects the mask. For example an imperfection having an affect on features a few micrometers away may be classified differently than an imperfection that affects features tens of micrometers away from the imperfection.

Various implementations of the invention account for different categories of imperfections based upon the imperfections range. With various implementations, imperfections having a range of zero to a few micrometers are classified as proximity errors or proximity imperfections, while imperfections having a range of a few micrometers to tens of millimeters are classified as long range errors or long range imperfections. Various implementations of the invention provide that the total error in the masks critical dimension (ΔCD(x, y)) as a given location of the mask layout is a combination of the proximity errors and the long range errors, as expressed in the following equation.

ΔCD(x,y)=ΔCDProximity(x,y)+ΔCDLongRange(x,y) (1)

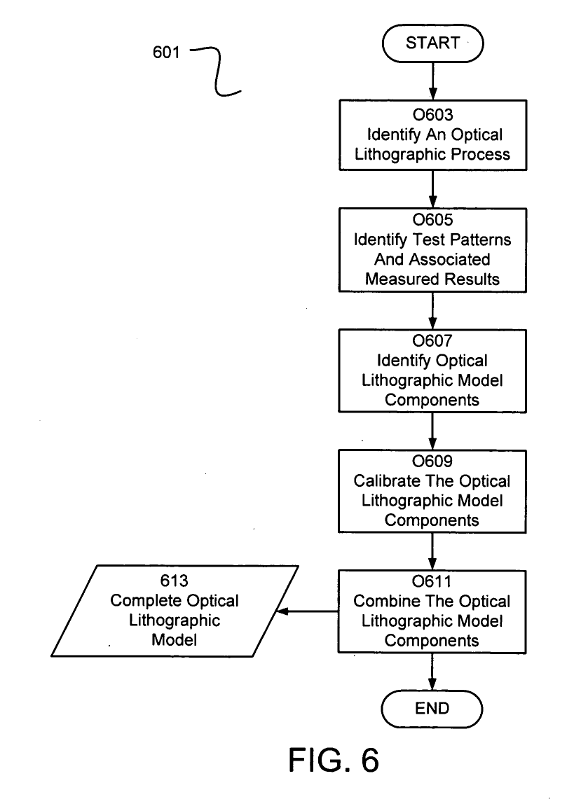

FIG. 6 illustrates a shape based optical lithographic model calibration flow that may be provided according to various implementations of the invention. As can be seen from this figure, the flow 601 includes an operation 603 for identifying an optical lithographic process, an operation 605 for identifying test patterns and associated measured results, an operation 607 for identifying components of an optical lithographic model, an operation 609 for calibrating the optical lithographic model components, and an operation 611 for combining the calibrated optical lithographic model components into a complete optical lithographic model 613.

As stated previously, during a pattern correction process, the optical lithographic process of interest is simulated, which requires a model that accurately represents the process. In order to calibrate a model, physically meaningful descriptions of the process must be quantified. With various implementations of the invention, the operation 605 generates a mask test pattern, causes the mask test pattern to be manufactured as a test mask, measuring various physical properties of the manufactured test mask, and then compares the expected or intended physical properties to the measured physical properties. Still, with other implementations of the invention, a mask test pattern has previously been manufactured and measured. Accordingly, the operation 605 for identifying a test pattern and associated measured results may access or identify a test pattern and the associated physical properties measured from a manufactured copy of the test pattern. Often, the measured physical properties are referred to herein as the measured results.

With various implementations of the invention, the test pattern may include features sensitive to long range process effects, process uniformity, pattern density loading, lithography effects, and etch effects. Additionally, assist featured present in a mask, but designed not to print during the optical lithographic process may be included, such as for example sub resolution assist features.

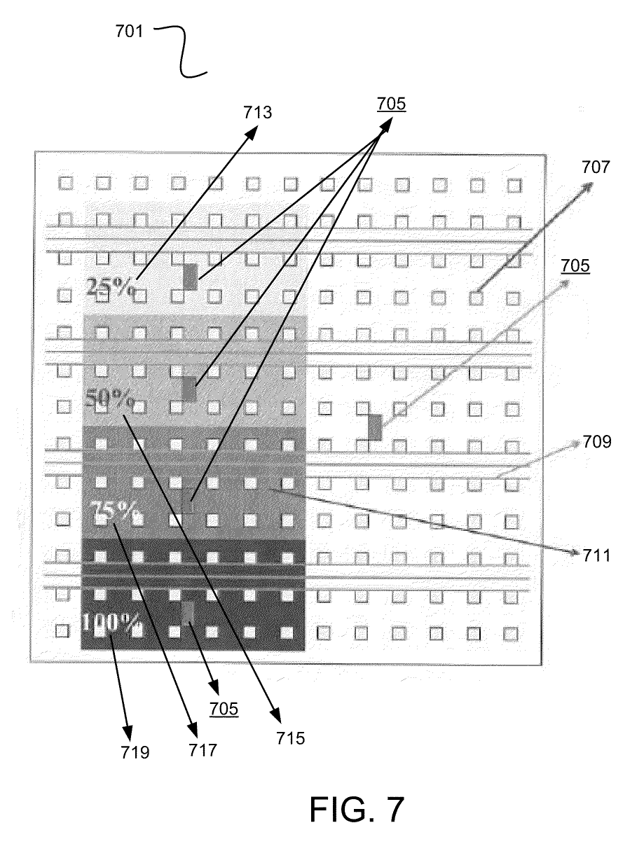

FIG. 7 illustrates a mask test pattern 701. As stated, in various implementations of the invention, a mask test pattern may be generated and manufactured. With other implementations of the invention, a mask test pattern, such as the test pattern 701 have previously been generated, manufactured, and measured. As can be seen from this figure, the mask test pattern 701 includes proximity test structures 705, long range uniformity test structures 707, long range density test structures 709, and background density areas 711. As can be seen, the background density areas may have various density levels, such as for example the 25% pattern fill area 713, the 50% pattern fill area 715, the 75% pattern fill area 717, and the 100% pattern fill area 719.

In various implementations of the invention, the long range density test structures 709 are arranged horizontally and embedded across the layout in regions having varying pattern area density, such as for example regions 717 and 715. With various implementations of the invention, the long range uniformity test structures 707 are distributed in a rectangular array over the entire layout. Still, with various implementations of the invention, the proximity test structures 705 may include various combinations of lines, spaces, end to end line and space features, posts, or contacts. With various implementations of the invention a plurality of these features are placed in various locations of the mask layout.

### Model Calibration

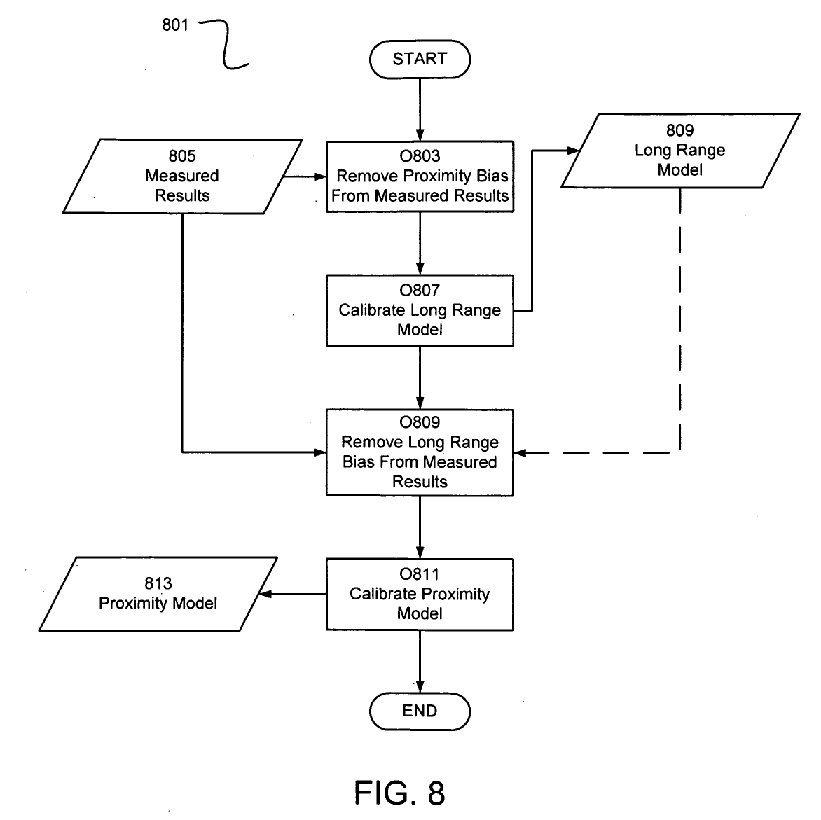

Returning to FIG. 6, the flow 601 includes the operation 609 for calibrating the optical lithographic model components. As stated above, the total error in the masks critical dimension (ΔCD(x, y)) at a given location of the mask layout is a combination of the proximity errors and the long range errors, as expressed in the following equation. Accordingly, with various implementations of the invention, an optical model may be comprised of a proximity component and a long range component. FIG. 8 illustrates a calibration flow 801 that may be provided according to various implementations of the present invention to perform the operation 609 shown in FIG. 6.

As can be seen from FIG. 8, the flow 801 includes an operation 803 for removing any proximity bias from measured results 805, an operation 807 for calibrating a long range model 807, an operation 809 for removing the long range bias from the measured results 805, and an operation 811 for calibrating a proximity model 813. In various implementations of the invention, the operation 803 removes the proximity bias from the measured results by directly sampling any proximity effects upon the long range features, such as the long range uniformity test structure 707 of FIG. 7. With various implementations of the invention, the proximity effect bias is removed from the measured results 805 first, as described above, enabling the long range model to be calibrated. With other implementations of the invention, the long range bias is removed first, enabling the proximity model to be calibrated, wherein the proximity model may be utilized to remove the long range bias from the measured results 805 enabling the long range model to be calibrated.

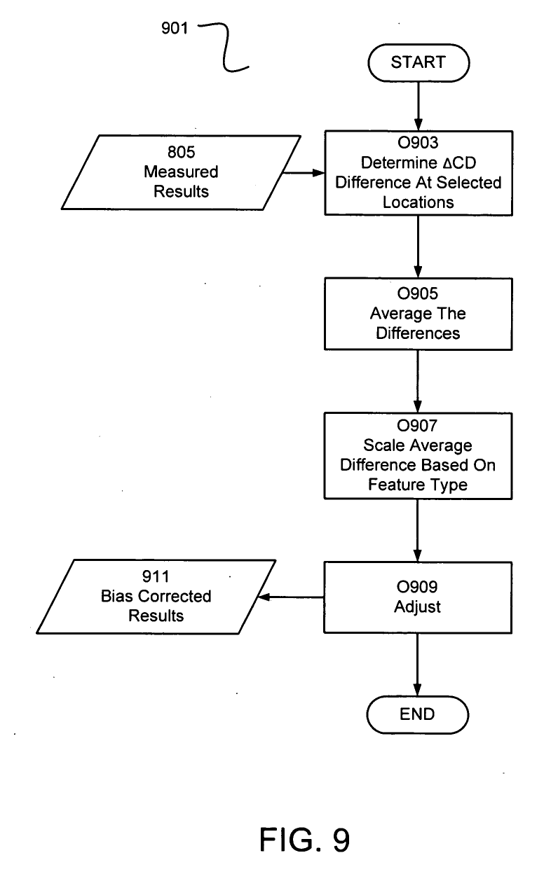

With various implementations of the invention, the operation 803 may be performed according to the bias removal method 901 illustrated in FIG. 9. As can be seen from this figure, the method 901 includes an operation 903 for determining a difference between the critical dimension error (ΔCD(x, y)) at selected locations from the expected critical dimension error. For example, the long range uniformity test structures 707 would ideally have identical critical dimension errors. Any variance between the errors is due to proximity effect bias. Accordingly, in various implementations of the invention, the operation 903 may determine the difference between the measured critical dimension errors and the expected critical dimension errors as selected locations of the test mask. Those of skill in the art can appreciate that the method 901 may be applied to remove either long range or proximity effect bias from the measured results 805.

The method 901 further includes an operation 905 for averaging the determined differences, an operation 907 for scaling the average difference, and an operation 909 for adjusting the measured results to account for the bias, resulting an a set of bias corrected results 911.

### Long Range Model Calibration

Returning again to FIG. 8, the flow 801 includes the operation 807 for calibrating the long range model 809. In various implementations of the invention, the long range mask critical dimension errors are described by a density loading function that includes a convolution of the pattern density with a Gaussian point spread function, as illustrated in Equation (2). Equation (2) and its terms, along with long range mask processing modeling is discussed in further detail in “A New Long-Range Proximity Effect In Chemically Amplified Photoresist Processes: Chemical Flare,” by T. Brunner et al., Proceedings Of SPIE, vol 5753, pp. 261-268, 2005, which article is incorporated entirely herein by reference. With various implementations of the invention, the Gaussian point spread function has a standard deviation that is characteristic of the range of the optical lithographic process, such as for example 8000 micrometers. Still, with further implementations of the invention, the long range model may include multiple Gaussian convolution terms, wherein each term may describe an alternate optical lithographic process range of interest.

$$Δ CDLongRange ( x , y ) = {A}_{0} + {\sum }_{i = 1}^{N} {C}_{i} \cdot [ D ( x , y ) * {e}^{- \frac{{x}^{2} + {y}^{2}}{2 {σ}_{i}^{2}}} ] + {A}_{1} x + {A}_{2} y + {A}_{3} xy + {A}_{4} {x}^{2} + {A}_{5} {y}^{2} \qquad ( 2 )$$

As can be seen from Equation (2), the long range model may also include polynomial terms that describe the systematic components of the mask process critical dimension non-uniformity. Referring to Equation (2), D(x,y) represents the pattern area density at the mask layout location (x,y), N represents the number of density loading terms with characteristic ranges σ₁. With various implementations of the invention, the number of Gaussian sigma's (σᵢ) is determined based upon the density data. In various implementations of the invention, the number and order of will vary. The polynomial order may be determined based upon the optical lithographic process of interest. The coefficient terms, such as A₁, are determined by fitting the bias corrected measured results 911 to the model.

### Proximity Effects Model Calibration

As stated above, proximity effects, or short range, are the errors that have an influence or effect on features within a few micrometers of the error. Typically these effects are manifest in electron beam lithography and pattern etching. These effects are discussed in greater detail in “Dry Etch Proximity Modeling In Mask Fabrication,” by Yuri Granik et al., Proceeding of SPIE, vol. 5130, pp. 86-91, 2003, and “Correction For Etch Proximity New Models And Applications,” Proceedings of SPIE, vol. 4346, pp. 98-112, 2001, which articles are incorporated entirely herein by reference.

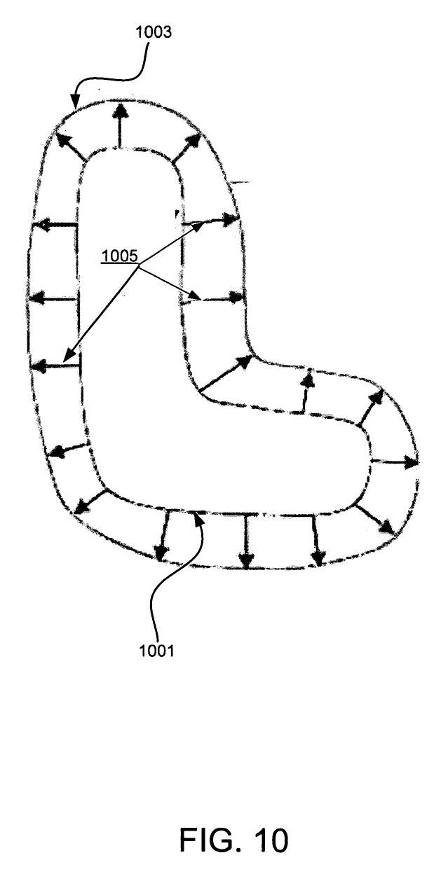

Various implementations of the invention provide that a variable etch bias (VEB) model is employed to describe the proximity effect components of the optical lithography process. Variable etch bias models represent a position dependent bias (b), given relative to a mask shape edge. For example, FIG. 10 illustrates an intended mask shape 1001, a realized mask shape 1003, and position dependent bias values 1005. In various implementations of the invention, the proximity components of the mask process model are calibrated based upon conventional optical proximity correction model calibration techniques.

### Pattern Correction Flow

Returning again to FIG. 6, the flow 601 includes the operation 611 for combining the optical lithographic model components, such as for example the long range and proximity effect components into the complete model 613. With various implementations of the invention, the models outputs are summed, resulting in the combined critical dimension error.

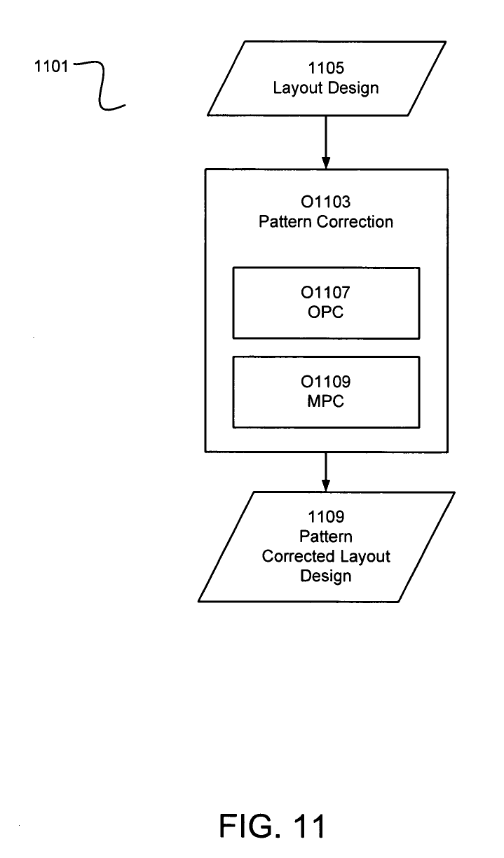

FIG. 11 illustrates a pattern correction flow 1101 that may be provided according to various implementations of the present invention. As can be seen from this figure, the flow 1101 includes an operation 1105 for performing pattern correction on a layout design 1105, resulting in a pattern corrected layout design 1109. As can be seen, the pattern correction process includes an optical proximity correction process 1107 and a mask process correction flow 1109. In various implementations of the invention, the mask process correction flow 1109 is the flow 601 illustrated in FIG. 6. The pattern correction flow 1101 may be utilized to correct a layout design to improve both the fidelity of the optical lithographic process as well as the accuracy of the manufactured mask shapes.

### CONCLUSION

Various implementations of the invention provide methods and apparatus for calibrating models of an optical lithographic process. In various implementations, a complete model of an optical lithographic process may be formed by combining different physical ranges and components describing the optical lithographic process.

With various implementations of the invention, an optical lithographic process model may be calibrated by generating and applying a set of test patterns to the optical lithographic process, identifying test patterns and associated measured results that correspond to the discrete components of the optical lithographic model, calibrating the discrete components of the optical lithographic model based on the identified test patterns and measured results, and combining the calibrated components into a complete model. In some implementations of the invention, the discrete components of the optical lithographic model represent different physical effects of the optical lithographic process. Alternately or additionally, with various implementations of the invention the generated test patterns may include test structures sensitive to proximity effects, long-range pattern density, and long-range process non-uniformity.

Although certain devices and methods have been described above in terms of the illustrative embodiments, the person of ordinary skill in the art will recognize that other embodiments, examples, substitutions, modification and alterations are possible. It is intended that the following claims cover such other embodiments, examples, substitutions, modifications and alterations within the spirit and scope of the claims.

What is claimed is:

1. A computer implemented method comprising:
identifying an optical lithographic process, the optical lithographic process having a plurality of component characteristics;
identifying a plurality of test patterns printable by the optical lithographic process;
identifying a plurality of measured results corresponding to the plurality of test patterns;
identifying a plurality of optical lithographic model components;
calibrating the optical lithographic model components based in part upon the plurality of measured results; and
combining the optical lithographic model components into a complete optical lithographic model.

2. The method recited in claim 1, further comprising saving the complete model to a memory storage location.

3. The method recited in claim 2, the plurality of optical lithographic model components being either long range components or proximity effect components.

4. The method recited in claim 3, calibrating the optical lithographic model components based in part upon the measured results comprising:
generating a set of long range result data by removing any proximity effects from the plurality of measured results;
calibrating the long range components based in part upon the set of long range result data;
utilizing the calibrated long range components to generate a set of proximity effects result data by removing any long range effects from the measured results; and
calibrating the proximity effect components based in part upon the proximity effects result data.

5. The method recited in claim 3, calibrating the optical lithographic model components based in part upon the measured results comprising:
generating a set of proximity effects result data comprising:
identifying a plurality of proximity measurements at various locations within the mask field, and
removing long range bias from the measured results;
calibrating the proximity effect models based upon the set of proximity effects result data;
utilizing the calibrated proximity effect models to generate a set of long range result data by removing the proximity effects from the measured results; and
calibrating the long range models based in part upon the long range result data.

6. The method recited in claim 1, the plurality of test patterns comprising:
shapes sensitive to proximity effects;
shapes sensitive to long range pattern density; and
shapes sensitive to long range optical lithographic process non-uniformity.
